(19) United States
(12) Patent Application Publication
(10) Pub. No.: US 2024/0173962 A1
(43) Pub. Date: May 30, 2024

(54) PRINTING METHOD AND ROBOT SYSTEM

(71) Applicant: SEIKO EPSON CORPORATION, Tokyo (JP)

(72) Inventor: Hidetoshi SAITO, SUWA-GUN FUJIMI-MACHI (JP)

(21) Appl. No.: 18/520,585

(22) Filed: Nov. 28, 2023

(30) Foreign Application Priority Data
Nov. 30, 2022 (JP) 2022-191196

(51) Int. Cl. B41J 2/045

(52) U.S. Cl. CPC B41J 2/04526; B41J 2/04505; B41J 2/04581

(57) ABSTRACT

A printing method for printing a plurality of lines using an ink ejection head that ejects ink; a robot that relatively moves the ink ejection head along a printing direction with respect to an object; and a detection section that detects a relative track of the ink ejection head with respect to an object, the printing method including an overlap width setting step of the detection section acquiring an undulation amount of the track in a direction orthogonal to the printing direction, and of setting an overlap width of the track when printing the plurality of lines based on the acquired undulation amount and a printing step of printing the plurality of lines on an object while the ink ejection head relatively moves so as to generate an overlap corresponding to the overlap width in printing the plurality of lines.

### CROSS-REFERENCE TO RELATED APPLICATIONS

The present application is based on, and claims priority from JP Application Serial Number 2022-191196, filed Nov. 30, 2022, the disclosure of which is hereby incorporated by reference herein in its entirety.

### BACKGROUND

### 1. Technical Field

The present disclosure relates to a printing method and a robot system.

### 2. Related Art

A three dimensional object printing device was known that combine operations of a plurality of movable sections to move an inkjet print head and print on a surface of a three dimensional object.

For example, JP-A-2013-202781 discloses a system for printing on a three dimensional object, comprising a joint arm robot, a print head, a piezo actuator arranged between them, and a detecting device that detects a position of a printing point. The robot is configured to move the print head along a surface of an object. As a result, printing can be performed in multiple passes including print trajectories adjacent to each other.

JP-A-2013-202781 discloses that a piezo actuator causes relative motion of the print head with respect to the robot. JP-A-2013-202781 discloses that when printing is performed in multiple passes by using this system while moving a print head in two printing trajectories adjacent to each other, an actual position of a printing point of a first print trajectory is detected, a deviation between a target position and an actual position is calculated, and a correction motion is performed in a second print trajectory so as to eliminate the deviation. As a result, a deviation between printing passes is suppressed, and an image without an error can be printed.

However, in the system described in JP-A-2013-202781, it is not possible to sufficiently eliminate a deviation between a target position and an actual position due to vibration or the like generated in the robot. In a case where the deviation is not sufficiently eliminated, a printing failure occurs in which a blank is generated between printing passes or an overlap between printing passes is conspicuous.

### SUMMARY

A printing method according to an application example of the present disclosure is a printing method for printing a plurality of lines using an ink ejection head that ejects ink; a robot that relatively moves the ink ejection head along a printing direction with respect to an object; and a detection section that detects a relative track of the ink ejection head with respect to an object, the printing method including an overlap width setting step of the detection section acquiring an undulation amount of the track in a direction orthogonal to the printing direction, and of setting an overlap width of the track when printing the plurality of lines based on the acquired undulation amount and a printing step of printing the plurality of lines on an object while the ink ejection head relatively moves so as to generate an overlap corresponding to the overlap width in printing the plurality of lines.

A robot system according to an application example of the present disclosure is a robot system for printing a plurality of lines on an object, the robot system including an ink ejection head that ejects ink; a robot including a robot arm that relatively moves the ink ejection head along a printing direction with respect to an object; a detection section that detects a relative track of the ink ejection head with respect to an object; and a print control section that controls operations of the ink ejection head and the robot, wherein the print control section includes an undulation amount acquisition section that acquires an undulation amount of the track in a direction orthogonal to the printing direction and an overlap width setting section that sets an overlap width between the tracks when the plurality of lines is printed based on the acquired undulation amount and the ink ejection head prints the plurality of lines on an object while the robot relatively moves the ink ejection head so that an overlap corresponding to the overlap width is generated in printing the plurality of lines.

### BRIEF DESCRIPTION OF THE DRAWINGS

FIG. 1 is a perspective view showing an overall configuration of a robot system (printing device) according to a first embodiment.

FIG. 2 is a functional block diagram of the printing device shown in FIG. 1.

FIG. 3 is a plan view showing a movement stage and a liquid ejection head shown in FIG. 1.

FIG. 4 is a schematic diagram showing an outline of a printing method according to the first embodiment.

FIG. 5 is a flowchart for explaining the printing method according to the first embodiment.

FIG. 6 is a schematic diagram for explaining a printing method shown in FIG. 5.

FIG. 7 is a schematic diagram for explaining the printing method shown in FIG. 5.

FIG. 8 is a schematic diagram for explaining the printing method shown in FIG. 5.

FIG. 9 is a graph showing the relationship between a residual error in two directions D1 and D2 and a corresponding overlap width.

FIG. 10 is a schematic diagram for explaining a method of thinning out dots in a range OL corresponding to an overlap width.

FIG. 11 is a schematic diagram for explaining a method of thinning out dots in a range OL corresponding to an overlap width.

FIG. 12 is a flowchart for explaining a printing method according to a second embodiment.

FIG. 13 is a flowchart for explaining a printing method according to a third embodiment.

### DESCRIPTION OF EMBODIMENTS

Hereinafter, preferred embodiments of a printing method and a robot system of the present disclosure will be described in detail with reference to the accompanying drawings.

### 1. First Embodiment

First, a printing method and a robot system according to a first embodiment will be described.

### 1.1. Printing Device

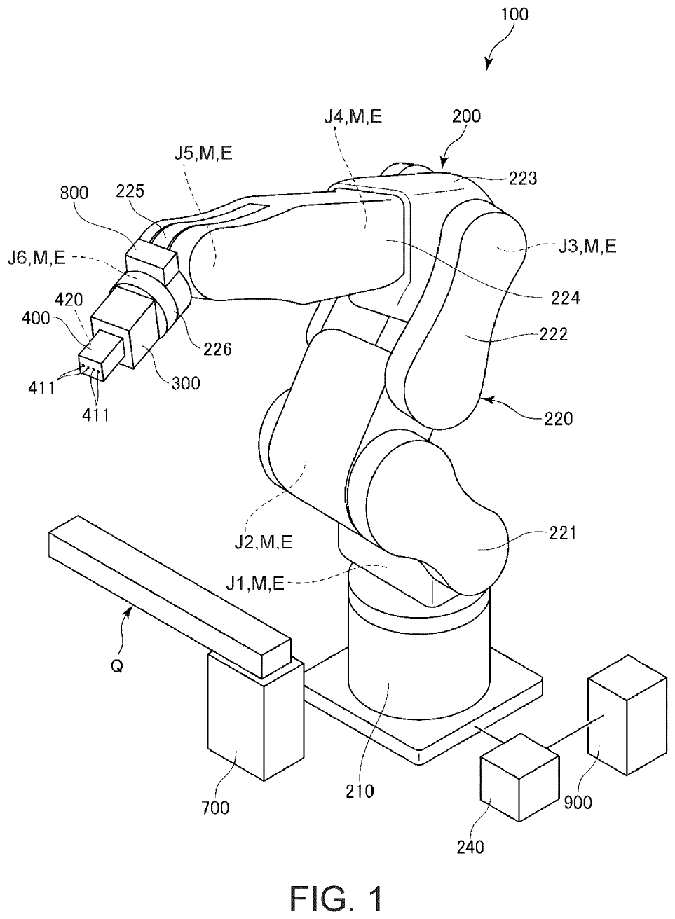

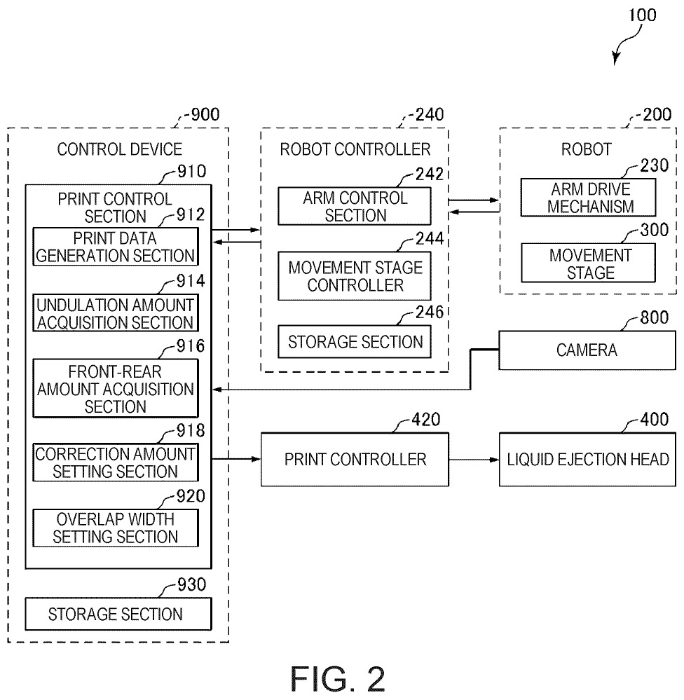

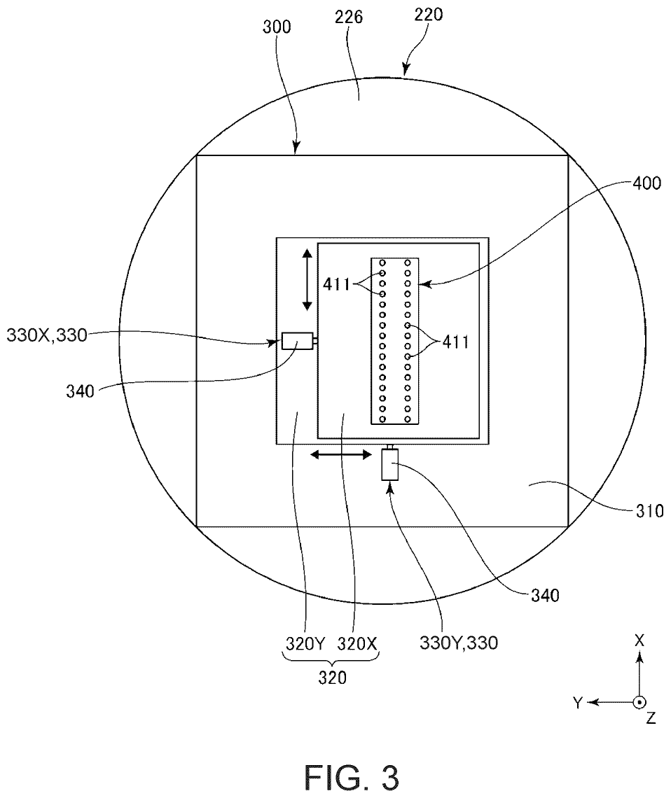

FIG. 1 is a perspective view showing an overall configuration of a robot system (printing device 100) according to a first embodiment. FIG. 2 is a functional block diagram of the printing device 100 shown in FIG. 1. FIG. 3 is a plan view showing a movement stage 300 and a liquid ejection head (ink ejection head) 400 shown in FIG. 1.

The printing device 100 shown in FIG. 1 includes a robot 200, a liquid ejection head 400, a fixing member 700 for supporting and fixing an object Q, a camera 800, and a control device 900.

The robot 200 is a six axes vertical articulated robot including six drive axes. The robot 200 includes a base 210 fixed to a floor, a robot arm 220 connected to the base 210, and a movement stage 300 attached to the robot arm 220. The number of the drive axes of the robot 200 may be less or more than six. The robot 200 may be a horizontal articulated robot or a multi-arm robot including a plurality of robot arms.

The robot arm 220 is a robot arm with a plurality of arms 221, 222, 223, 224, 225, and 226 that are pivotably connected, and includes six joints J1 to J6. Among them, the joints J2, J3, and J5 are bending joints, and the joints J1, J4, and J6 are torsional joints. The robot arm 220 is provided with an arm drive mechanism 230 shown in FIG. 2. The arm drive mechanism 230 is composed of motors M and encoders E provided in the joints J1, J2, J3, J4, J5, and J6 shown in FIG. 1. The motor M is a drive source that drives each of the joints J1, J2, J3, J4, J5, and J6. The encoder E detects the rotation amount of the motor M (the pivot angle of the arm).

As shown in FIG. 3, a liquid ejection head 400 is attached to a tip end section of the arm 226 via a movement stage 300. The liquid ejection head 400 shown in FIG. 3 includes an ink chamber (not shown), a diaphragm arranged on a wall surface of the ink chamber, and ink ejection apertures 411 connected to the ink chamber, and is configured such that ink in the ink chamber is ejected from the ink ejection apertures 411 by vibration of the diaphragm. However, the configuration of the liquid ejection head 400 is not particularly limited.

The printing device 100 also includes a print controller 420. As shown in FIG. 2, the liquid ejection head 400 is connected to the print controller 420. In the example of FIG. 1, a print controller 420 is attached to a tip end section of the arm 226 via the movement stage 300, similar to the liquid ejection head 400. The print controller 420 controls an operation of the liquid ejection head 400 based on a control signal output from the control device 900.

The print controller 420 includes, for example, a processor such as one or more central processing units (CPUs), a memory, an external interface, and the like. The print controller 420 may include a programmable logic device such as a field programmable gate array (FPGA) instead of or in addition to the CPU. The print controller 420 may be incorporated in the control device 900.

As shown in FIG. 3, the movement stage 300 includes a base section 310 connected to the arm 226, a stage 320 moving with respect to the base section 310, and a movement mechanism 330 for moving the stage 320 with respect to the base section 310. As shown in FIG. 3, when three axes orthogonal to each other are an X-axis, a Y-axis, and a Z-axis, the stage 320 includes a Y-stage 320Y movable in a direction along the Y-axis with respect to the base section 310, and an X-stage 320X movable in a direction along the X-axis with respect to the Y-stage 320Y. The X-stage 320X and the Y-stage 320Y are linearly guided in an X-axis direction and a Y-axis direction by a linear guide (not shown), and can smoothly move. The liquid ejection head 400 is attached to the X-stage 320X.

The movement mechanism 330 includes a Y-movement mechanism 330Y that moves the Y-stage 320Y in a direction along the Y-axis with respect to the base section 310 and an X-movement mechanism 330X that moves the X-stage 320X in a direction along the X-axis with respect to the Y-stage 320Y.

The Y-movement mechanism 330Y and the X-movement mechanism 330X each include a piezoelectric actuator 340 as a drive source. The piezoelectric actuators 340 vibrate using expansion and contraction of a piezoelectric element, and move the X-stage 320X and the Y-stage 320Y by transmitting the vibration to the X-stage 320X and the Y-stage 320Y. This makes it possible to reduce the size and weight of the movement stage 300. Driving accuracy of the movement stage 300 is improved. Further, since the piezoelectric actuator 340 has a large holding torque at a time of stopping, it is useful in that an additional brake is not required and that positional stability of the stage 320 at a time of stopping is high. A mechanism other than the piezoelectric actuator 340, for example, a mechanism in which a rack and pinion gear is combined with a rotary motor, a mechanism in which a ball screw is combined with a rotary motor, or the like may be used as the drive source.

The printing device 100 includes a robot controller 240. The motors M and the encoders E are connected to the robot controller 240. The robot controller 240 controls an operation of the robot 200 based on a control signal output from the control device 900.

The robot controller 240 includes, as functional sections, an arm control section 242, a movement stage controller 244, and a storage section 246.

The arm control section 242 controls the robot arm 220 to a target posture by outputting a control signal for controlling an operation of the arm drive mechanism 230.

The movement stage controller 244 moves the liquid ejection head 400 to a target position with respect to the robot arm 220 by outputting a control signal for controlling an operation of the movement stage 300. The movement stage controller 244 may be independent of the robot controller 240.

The storage section 246 stores a program necessary for an operation of the robot controller 240, data necessary for executing the program, and the like.

The robot controller 240 includes, for example, a processor, such as one or more CPUs, a memory, an external interface, and the like. The robot controller 240 may include a programmable logic device such as an FPGA instead of or in addition to the CPU.

The camera 800 is arranged on the arm 225 so as to face a tip end side of the robot arm 220. By thus arranging the camera 800 on the robot arm 220, an object Q can be imaged from a relatively short distance, and a clearer image can be obtained.

The arrangement of the camera 800 is not particularly limited, and it may be arranged, for example, on the arms 221 to 224 and 226, or at a position away from the robot 200. Examples of the camera 800 include a monochrome camera, a color camera, and a spectroscopic camera.

The control device 900 controls operations of the robot controller 240, the print controller 420, and the camera 800 to execute printing on an object Q. The control device 900 includes a print control section 910 and a storage section 930 as functional sections. The print control section 910 includes a print data generation section 912, an undulation amount acquisition section 914, a front-rear amount acquisition section 916, a correction amount setting section 918, and an overlap width setting section 920.

The print data generation section 912 generates print data and outputs the print data to the robot controller 240 and the print controller 420.

The undulation amount acquisition section 914 and the front-rear amount acquisition section 916 acquire an “undulation amount” and a “front-rear amount”, which will be described later. The undulation amount and the front-rear amount are the deviation amount from a scanning trajectory acquired for a track of the liquid ejection head 400.

The correction amount setting section 918 sets the amount (correction amount) by which the liquid ejection head 400 is moved with respect to the scanning trajectory based on the undulation amount and the front-rear amount. Then, the set correction amount is output to the robot controller 240.

The overlap width setting section 920 sets an overlap width between tracks of the liquid ejection head 400 when a plurality of lines is printed based on the undulation amount and the front-rear amount. Then, the set overlap width is output to the robot controller 240.

The storage section 930 stores a program necessary for an operation of the control device 900, data necessary for execution of the program, and the like.

The control device 900 is configured by, for example, a computer, and includes a processor (CPU) for processing information, a memory communicably connected to the processor, and an external interface. Various programs that can be executed by the processor are stored in the memory, and the processor realizes the above-described functions by reading and executing various programs stored in the memory.

Although the configuration of the robot system (printing device 100) according to the first embodiment has been described above, the movement stage 300 may not be a part of the robot 200, and may be arranged to support an object Q at a position away from the robot 200. Also in this case, the liquid ejection head 400 can be moved relative to the object Q by operating the movement stage 300 supporting the object Q.

### 1.2. Printing Method

Next, a printing method according to the first embodiment will be described. In the following description, a method using the above-described printing device 100 will be described as an example.

The printing method according to the first embodiment is a printing method for printing a plurality of lines on an object Q.

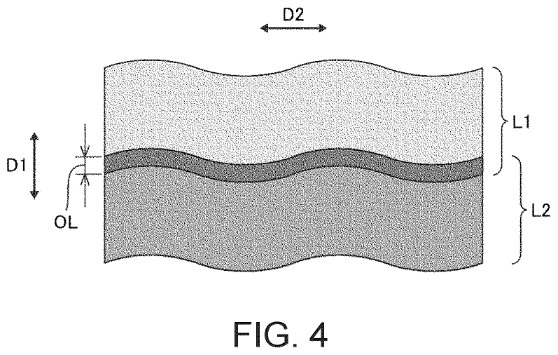

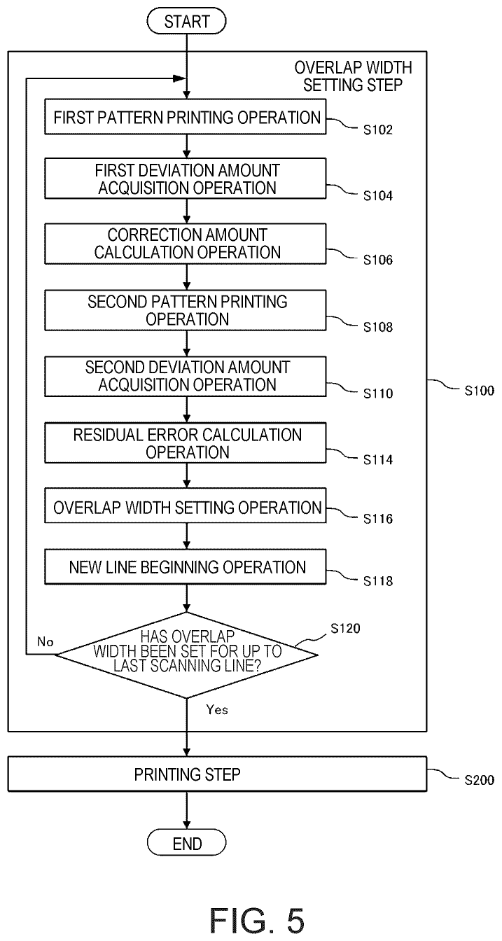

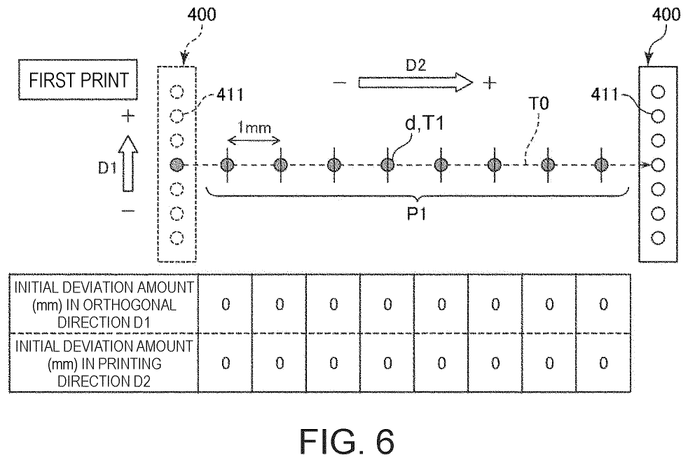

FIG. 4 is a schematic diagram showing an outline of the printing method according to the first embodiment. FIG. 5 is a flowchart for explaining the printing method according to the first embodiment. FIGS. 6 to 8 are schematic diagrams for explaining the printing method shown in FIG. 5.

As shown in FIG. 4, a plurality of lines including a first line L1 and a second line L2 adjacent to each other are printed by the printing method according to the first embodiment. The line refers to a path (scanning line) through which the liquid ejection head 400 passes. That is, the first line L1 can be printed by scanning the liquid ejection head 400 in a printing direction D2 by an operation of the robot 200 while ejecting ink from the liquid ejection head 400. The liquid ejection head 400 is deviated in an orthogonal direction D1 orthogonal to the printing direction D2 by an operation of the robot arm 220. Then, printing of the second line L2 is performed by scanning the liquid ejection head 400 in the printing direction D2 again.

In such a method, as described above, vibration or the like generated in the robot arm 220 causes a track of the liquid ejection head 400 to deviate. As a result, a printing failure occurs in which a blank is generated between lines or an overlap between lines is conspicuous.

Therefore, in the printing method according to the first embodiment, a deviation of a track of the liquid ejection head 400 is detected, and an overlap width between lines is set based on a detection result. An overlap width refers to a width in the orthogonal direction D1 in the range where the first line L1 and the second line L2 overlap. As a result, the overlap width can be optimized, and even when a blank is generated between lines or a change in density is generated due to an overlap between the lines, it can be made inconspicuous. As a result, high-quality printing can be performed on an object Q.

As shown in FIG. 5, the printing method according to the first embodiment includes an overlap width setting step S100 and a printing step S200. Hereinafter, each step will be described.

### 1.2.1. Overlap Width Setting Step

The overlap width setting step S100 includes operations from step S102 to step S118.

In step S102, an object different from an object to be printed, that is, a temporary object, is prepared as an object Q. This is because the object to be printed is prevented from being stained by printing a first pattern P1, which is a test pattern, as shown in FIG. 6. The temporary object may be another object having the same shape as that of the object to be printed, or a coating layer may be formed on a surface of the object to be printed. Examples of material constituting the coating layer include paper and resin. The coating layer may be removed after the overlap width setting step S100.

In step S102, the print data generation section 912 of the control device 900 generates print data corresponding to the first pattern P1. Then, the robot controller 240 creates a scanning trajectory TO of the liquid ejection head 400 corresponding to the print data. The liquid ejection head 400 prints the first pattern P1 in a range corresponding to the first line L1 of an object Q based on the created scanning trajectory TO. In the present application, the print in step S102 is also referred to as “first print”. The first pattern P1 is a pattern in which dots d are arranged at equal intervals in the printing direction D2. In step S102, the robot arm 220 operates so that the liquid ejection head 400 moves along the printing direction D2. In step S102, the movement stage 300 is not operated. That is, the scanning trajectory TO is a trajectory of the liquid ejection head 400 which is scanned only by the robot arm 220. While the liquid ejection head 400 is moved along the printing direction D2 by the robot arm 220, the liquid ejection head 400 performs printing on an object Q. Such an operation of the robot 200 and the liquid ejection head 400 is referred to as a first pattern printing operation.

In step S104, the camera 800 detects the first pattern P1 obtained by the first pattern printing operation. Specifically, the camera 800 acquires an image of the first pattern P1. The undulation amount acquisition section 914 of the control device 900 calculates a position of a dot d from an image acquired by the camera 800. Thus, a track T1 of the liquid ejection head 400 relative to an object Q is detected. That is, a position of a dot d is regarded as a track T of the liquid ejection head 400. In this specification, a concept including a path of the liquid ejection head 400 scanned by the robot 200 and a speed on the path, which are created by the robot controller 240, is referred to as a “scanning trajectory”. A concept including a path on which the liquid ejection head 400 actually moves and a speed on the path is referred to as a “track”.

In step S104, the undulation amount acquisition section 914 of the control device 900 acquires at least a deviation amount in a direction orthogonal to the printing direction D2 (orthogonal direction D1). The deviation amount in the orthogonal direction D1 refers to a distance between the scanning trajectory TO and a dot d (track T1) in the orthogonal direction D1, which is acquired for each dot d, as shown in FIG. 6. In FIG. 6 and other drawings of the present application, for convenience of description, a case of deviation above the scanning trajectory TO is defined as a positive deviation amount, and a case of deviation below the scanning trajectory TO is defined as a negative deviation amount. Such an operation of the control device 900 is referred to as a first deviation amount acquisition operation. A deviation amount obtained from the first pattern P1 is also referred to as an “initial deviation amount”.

A first pattern P1 shown in FIG. 6 includes eight dots d in total, and both an initial deviation amount in the orthogonal direction D1 and an initial deviation amount in the printing direction D2 are 0 mm. That is, in the first pattern P1 shown in FIG. 6, a track T1 of the liquid ejection head 400 coincides with a scanning trajectory TO, which indicates an ideal state.

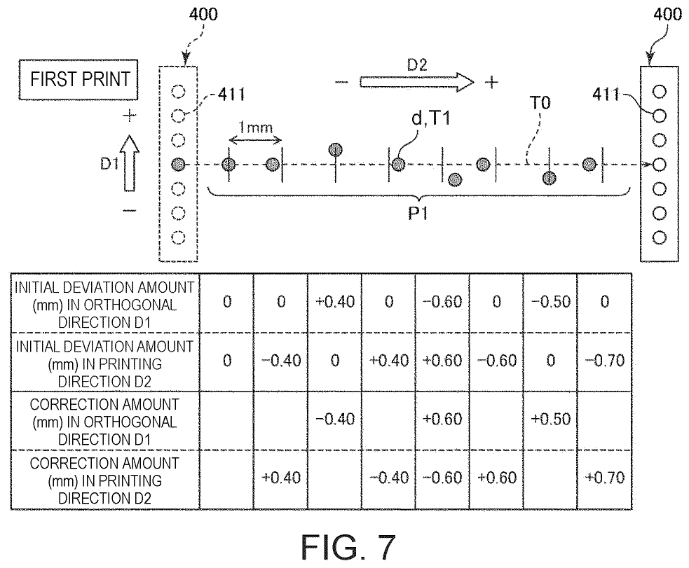

On the other hand, a first pattern P1 shown in FIG. 7 shows a non-ideal state.

In the example shown in FIG. 7, three dots d are deviated in the orthogonal direction D1, and five dots d are deviated in the printing direction D2. Such a deviation from the scanning trajectory TO occurs due to various causes. The cause may be, for example, vibration generated in the robot 200.

In the present embodiment, the front-rear amount acquisition section 916 of the control device 900 also acquires an initial deviation amount in the printing direction D2. As shown in FIG. 7, when a pattern in which dots d are printed at intervals of, for example, 1 mm is regarded as an ideal state, the initial deviation amount in the printing direction D2 refers to a distance between the ideal state in the printing direction D2 and a printing result, which is acquired for each dot d. In each drawing of the present application, for convenience of description, a case of being deviated forward in the printing direction D2 from the ideal state is defined as a positive deviation amount, and a case of being deviated rearward is defined as a negative deviation amount. The ideal state in the printing direction D2 in FIGS. 6 to 8 indicates a state in which dots d is arranged at an intersection of the scanning trajectory TO and a line orthogonal thereto.

In step S106, the correction amount setting section 918 of the control device 900 calculates amount (correction amount) by which the liquid ejection head 400 is moved in a direction of reducing a deviation amount based on the initial deviation amount obtained by the first deviation amount acquisition operation. The correction amount is calculated based on the initial deviation amount. A calculation method may be a method based on an experiment or a simulation, and is not particularly limited, but as an example, as shown in FIG. 7, a method of moving in an opposite direction with the same movement amount as the acquired initial deviation amount can be mentioned. That is, each of correction amounts shown in FIG. 7 is a value obtained by multiplying the acquired initial deviation amount by −1. The storage section 930 of the control device 900 stores the correction amount for each scanning line in a state synchronized with a scanning of the liquid ejection head 400, that is, in a state linked to a position of the liquid ejection head 400. Such an operation of the control device 900 is referred to as a correction amount calculation operation.

The correction amount may be reflected on a scanning trajectory TO in the printing step S200 described later, and is desirably reflected on an operation of the movement stage 300 in the printing step S200. That is, the correction amount may be a control value for correcting a track T1 by reflecting it in an operation of the robot arm 220, and is desirably used as a control value for correcting a track T1 by reflecting it in the operation of the movement stage 300. As a result, a track T1 can be corrected more accurately, and finally, a good printing result can be obtained. In many cases, it is difficult for the robot arm 220 to suppress influence of vibration or the like depending on a scanning speed, and therefore it is useful to perform correction using the movement stage 300.

In step S108, a temporary object different from the temporary object prepared in step S102 is prepared as an object Q. Then, in step 108, the robot arm 220 and the movement stage 300 are used to print a second pattern P2 in a range corresponding to the first line L1 of the object Q. In the present application, the print in step S108 is also referred to as “second print”. The second pattern P2 is a pattern in which dots d are arranged at equal intervals in the printing direction D2, and is the same pattern as the first pattern P1. In step S108, the robot 200 operates so that the liquid ejection head 400 moves along the printing direction D2. It is desirable that a scanning trajectory TO generated by the robot controller 240 in the second print is the same as that in the first print. Further, in step S108, the movement stage 300 operates so that the liquid ejection head 400 moves along the orthogonal direction D1 and the printing direction D2.

In the present embodiment, in step S108, the correction amount calculated in the correction amount calculation operation is reflected in an operation of the movement stage 300 As described above, the correction amount is set for a purpose of correcting a deviation from an ideal state caused by vibration or the like generated in the robot 200. As a scanning trajectory T0 to be created by the robot controller 240 in the second print, the same scanning trajectory T0 as in the first print is desirably used. As a result, there is a high probability that a deviation from the ideal state caused by the above-described causes is the same in the second print as in the first print. As a result, when a correction is performed using a correction amount calculated in the correction amount calculation operation, the probability that a deviation can be accurately corrected increases. Such an operation of the liquid ejection head 400 is referred to as a second pattern printing operation.

In step S110, the camera 800 detects the second pattern P2 obtained by the second pattern printing operation. Specifically, the camera 800 acquires an image of the second pattern P2. Then, the control device 900 calculates a position of dots d from the image acquired by the camera 800. Thus, a track T2 of the liquid ejection head 400 relative to an object Q is detected.

Then, in step S110, the undulation amount acquisition section 914 of the control device 900 acquires at least a deviation amount in the orthogonal direction D1. In the present embodiment, deviation amount is acquired in both the orthogonal direction D1 and the printing direction D2. Such an operation of the control device 900 is referred to as a second deviation amount acquisition operation. A deviation amount acquired from the second pattern P2 is also referred to as a “corrected deviation amount”. In the present embodiment, the corrected deviation amount in the orthogonal direction D1 is defined as an “undulation amount”, and the corrected deviation amount in the printing direction D2 is defined as a “front-rear amount”.

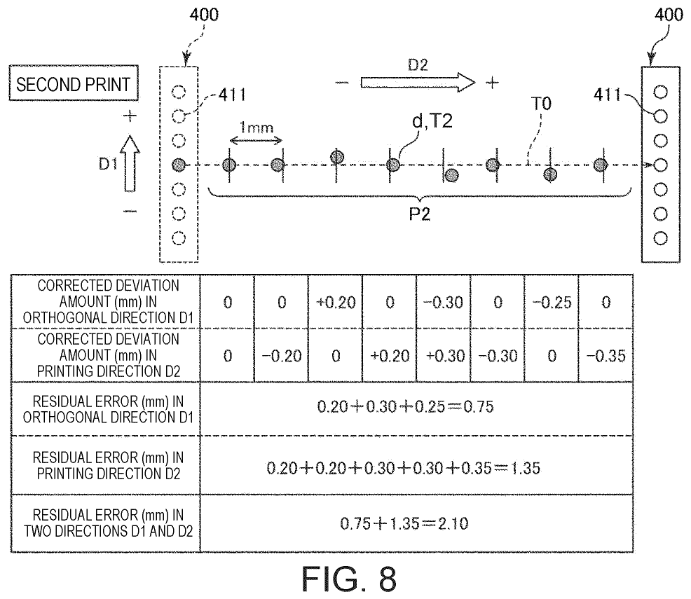

In step S114, the absolute value of the undulation amount (corrected deviation amount in the orthogonal direction D1) is obtained for each dot d of the second pattern P2. Then, as shown in FIG. 8, the obtained absolute values are summed over the entire second pattern P2. The sum of the obtained absolute values is referred to as a residual error in the orthogonal direction D1. In step S114, the absolute value of the front-rear amount (corrected deviation amount in the printing direction D2) is obtained for each dot d of the second pattern P2. Then, as shown in FIG. 8, the obtained absolute values are summed over the entire second pattern P2. The sum of the obtained absolute values is referred to as a residual error in the printing direction D2.

In step S114, as shown in FIG. 8, a residual error in the orthogonal direction D1 and a residual error in the printing direction D2 are summed. Thus, a residual error in the two directions D1 and D2 are calculated. This residual error is a residual error of the first line L1.

Such an operation of the control device 900 is referred to as a residual error calculation operation. A calculation of a residual error may be performed as necessary, or may be omitted. In this case, an overlap width (to be described later) may be directly set on the basis of the undulation amount or the front-rear amount, or calculation different from the above may be performed on the undulation amount or the front-rear amount, the overlap width may be set based on the obtained calculation result.

In step S116, the overlap width setting section 920 of the control device 900 sets the overlap width based on a residual error in the two directions D1 and D2. This overlap width means an overlap width to be set when the second line L2 is overlapped with the first line L1 based on a residual error of the first line L1. Therefore, the storage section 930 of the control device 900 stores this overlap width in a state linked to the first line L1. Such an operation of the control device 900 is referred to as an overlap width setting operation.

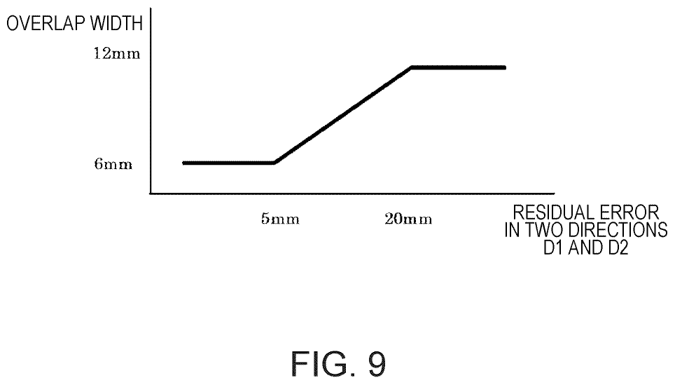

The method of obtaining an overlap width based on a residual error in the two directions D1 and D2 is not particularly limited, but as an example, there is a method using the correlation between a residual error in the two directions D1 and D2 and an overlap width shown in FIG. 9. FIG. 9 is a graph showing the relationship between a residual error in two directions D1 and D2 and a corresponding overlap width. By using the relationship shown in FIG. 9, an overlap width suitable for a residual error in the two directions D1 and D2 can be derived. In the example of FIG. 9, when a residual error in the two directions D1 and D2 is 5 mm, it is understood that an overlap width may be set to 6 mm.

In the relationship shown in FIG. 9, an overlap width is set to be wider as a residual error in the two directions D1 and D2 is larger. This utilizes a phenomenon in which printing failure becomes inconspicuous even when a residual error exists by widening an overlap width in accordance with a residual error. That is, when there is a residual error, a rapid change tends to occur in print density. However, by setting an overlap width to be wide, it is possible to moderate the change in print density and make the change in print density inconspicuous.

In step S118, a new scanning line of the liquid ejection head 400 is begun by the robot arm 220. That is, the liquid ejection head 400 is moved from a position of the first line L1 to a position of the second line L2 along the orthogonal direction D1. A line feed width at this time is usually set equal to a length of the liquid ejection head 400 in the orthogonal direction D1. On the other hand, when an overlap width set in the overlap width setting operation is greater than zero, a value obtained by subtracting the overlap width from a normal line feed width is set as a line feed width to be set. For example, when the length of the liquid ejection head 400 in the orthogonal direction D1 is 24 mm and the overlap width is 6 mm, the line feed width to be set in step S118 is 18 mm. Such an operation of the robot arm 220 is referred to as a new line beginning operation.

When only the initial deviation amount in the orthogonal direction D1 is acquired, step S114 may be omitted, and in step S116, an overlap width may be calculated only from a residual error in the orthogonal direction D1. In this case, an overlap width may be set based on a new graph or the like in which the horizontal axis of the graph shown in FIG. 9 is a residual error in the orthogonal direction D1.

In step S120, it is determined whether it is necessary to set an overlap width for a new scanning line. That is, it is determined whether or not the overlap width has been set for up to the last scanning line in printing a plurality of lines. When the setting has not been completed, the process returns to step S102. When the setting is completed, the process proceeds to the printing step S200.

When the process returns to the step S102, a residual error of the second line L2 is obtained in the second steps S102 to S118, and an overlap width is set based on the residual error. By repeating this operation until the last scanning line, the overlap width can be set for all the scanning lines. Based on the overlap width set as described above, printing can be performed with an appropriate overlap width in the printing step S200 (to be described later).

### 1.2.2. Printing Step

In the printing step S200, the liquid ejection head 400 prints a plurality of lines on an object Q while the robot arm 220 and the movement stage 300 relatively move the liquid ejection head 400 so that an overlap occurs corresponding to an overlap width set in the overlap width setting step S100. That is, the control device 900 controls an operation of the robot 200 so as to overlap scanning lines on the basis of an overlap width stored in a state linked to each scanning line. The control device 900 controls an operation of the movement stage 300 so as to correct a position of the liquid ejection head 400 based on a correction amount stored in a state linked to a position of the liquid ejection head 400 in each scanning line. As a result, scanning lines can be overlapped with each other at an appropriate overlap width corresponding to a residual error between lines. Therefore, it is possible to perform high-quality printing without generating a blank between lines or making a change in print density conspicuous. In particular, this printing method is capable of printing even when an object Q is a three dimensional object. In a case of printing on a three dimensional object, a posture of the robot arm 220 greatly varies depending on a position of the scanning line, and vibration of the robot arm 220 also varies. Therefore, as in the present embodiment, by experimentally finding an appropriate overlap width for each scanning line and printing a plurality of lines based on the overlap width, it is possible to suppress influence on a printing result even when the vibration of the robot arm 220 changes.

In the present embodiment, since a residual error is reduced by the movement stage 300, an overlap width can be suppressed to be smaller as a result. Further, the movement stage 300 can correct a position of the liquid ejection head 400 with higher accuracy and at higher speed than the robot arm 220. As a result, higher quality printing can be performed at a higher speed.

When printing is performed in the printing step S200, the overlap width setting section 920 may modify print data in a range corresponding to an overlap width. This function is, for example, a function of modifying print data so as to thin out dots in a range corresponding to an overlap width. Thus, it is possible to suppress print density in a range corresponding to an overlap width from becoming excessively high.

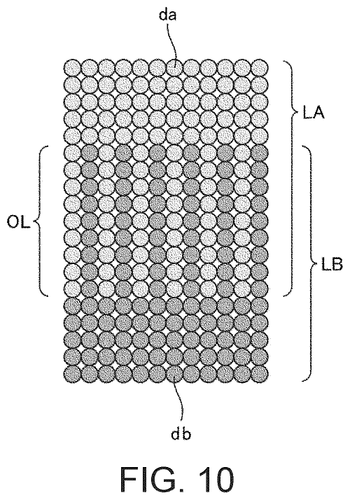

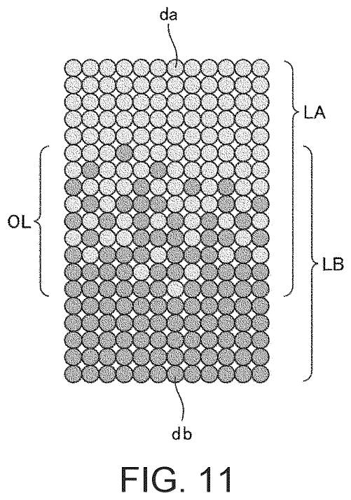

FIGS. 10 and 11 are schematic diagrams for explaining a method of thinning out dots in a range OL corresponding to an overlap width. FIGS. 10 and 11 show an example in which dots da constituting a scanning line LA and dots db constituting the scanning line LB are thinned out in the range OL in which adjacent scanning lines LA and LB overlap each other.

In FIG. 10, the dots da and db are thinned out in a comb-tooth shape in the range OL corresponding to the overlapping width. That is, in the range OL shown in FIG. 10, a set of comb-shaped dots da and a set of comb-shaped dots db are meshed with each other. Thus, an excessive increase in the print density in the range OL is suppressed.

In FIG. 11, the dots da and db are thinned out in the range OL corresponding to the overlap width based on a gradation dispersion. The gradation dispersion is a process of dispersing dots so as not to have a visually specific frequency. That is, in the range OL shown in FIG. 11, a set of dots da thinned out based on the gradation dispersion and a set of dots db thinned out based on the gradation dispersion are meshed with each other. Thus, an excessive increase in the print density in the range OL is suppressed. With the gradation dispersion, a printing failure due to a residual error becomes more inconspicuous as compared with other thinning methods. Therefore, even when a residual error cannot be sufficiently suppressed, it is possible to make a printing failure more inconspicuous without securing an overlap width larger than necessary. As a result, high-quality printing can be performed without significantly reducing a printing speed.

### 2. Second Embodiment

Next, a printing method according to a second embodiment will be described.

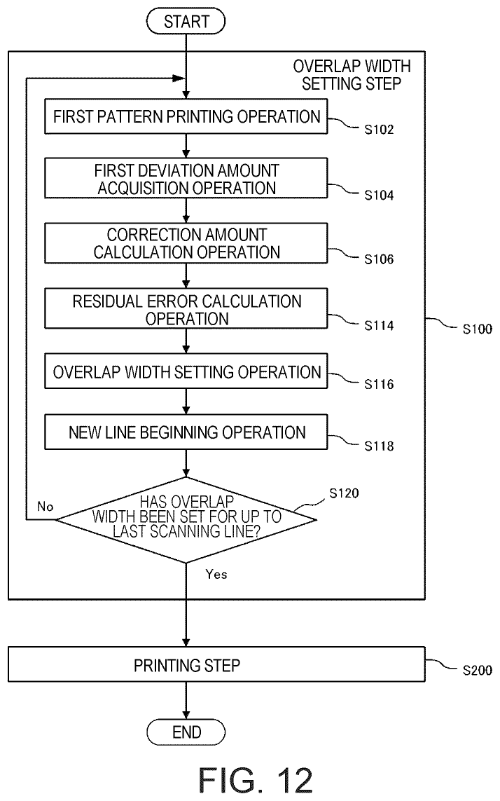

FIG. 12 is a flowchart for explaining a printing method according to the second embodiment.

The second embodiment will be described below, but in the following description, the difference from the first embodiment will be mainly described, and the description of the same matters will be omitted. In FIG. 12, the same configurations as those of the first embodiment are denoted by the same reference symbols.

A printing method according to the second embodiment is the same as the printing method according to the first embodiment except that calculation methods of an “undulation amount” and a “front-rear amount” for setting an overlap width are different.

In the first embodiment described above, in the overlap width setting step S100, an initial deviation amount and a corrected deviation amount are sequentially obtained, and then the corrected deviation amount is regarded as the “undulation amount” and the “front-rear amount”. Then, an overlap width is set based on a residual error calculated from the undulation amount and the front-rear amount.

On the other hand, in the present embodiment, an initial deviation amount is regarded as an “undulation amount” and a “front-rear amount”.

Specifically, steps S108 and S110 relating to the printing of the second pattern P2 shown in FIG. 5 are omitted in a printing method shown in FIG. 12.

On the other hand, in step S104, an initial deviation amount in the orthogonal direction D1 is defined as an “undulation amount”, and an initial deviation amount in the printing direction D2 is defined as a “front-rear amount”. Then, in step S114, the absolute values of the undulation amount and the absolute values of the front-rear amount are obtained and summed to obtain a residual error in the orthogonal direction D1 and a residual error in the printing direction D2.

Also in the second embodiment as described above, the same effects as those of the first embodiment can be obtained.

In the second embodiment, printing and detection of the second pattern P2 can be omitted, so that the number of steps for setting an overlap width can be reduced. Thus, the overlap width can be set to a shorter time.

### 3. Third Embodiment

Next, a printing method according to a third embodiment will be described.

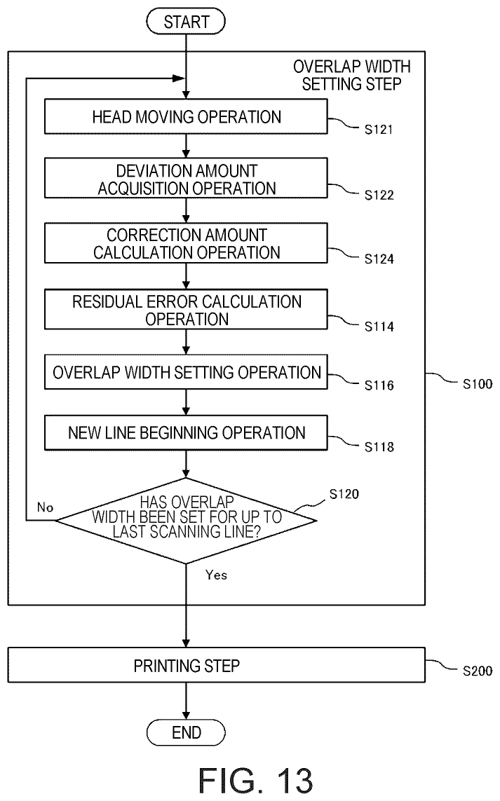

FIG. 13 is a flowchart for explaining a printing method according to a third embodiment.

The third embodiment will be described below, but in the following description, the difference from the first embodiment will be mainly described, and the description of the same matters will be omitted. In FIG. 13, the same configurations as those of the first embodiment are denoted by the same reference symbols.

A printing method according to the third embodiment is the same as the printing method according to the first embodiment and second embodiment, except that calculation methods of an “undulation amount” and a “front-rear amount” for setting an overlap width are different.

In the first embodiment and the second embodiment described above, the dots d included in each of the first pattern P1 and the second pattern P2 printed by the liquid ejection head 400 are detected, and the undulation amount and the front-rear amount are obtained based on positions of the dots d.

On the other hand, in the present embodiment, the liquid ejection head 400 itself is detected by the camera 800, and the undulation amount and the front-rear amount are obtained based on a position of the liquid ejection head 400.

Specifically, in a printing method shown in FIG. 13, steps S102, S104, S106, S108, and S110 shown in FIG. 5 are omitted. On the other hand, the printing method shown in FIG. 13 includes steps S121, S122, and S124.

Step S121 shown in FIG. 13 is similar to step S102 of the first embodiment in that a pattern is printed, but is different from the first embodiment in that an arbitrary pattern may be used. There is also an advantage that it is not necessary to eject ink from the liquid ejection head 400 in step S121. That is, in step S121 shown in FIG. 13, the robot arm 220 may scan the liquid ejection head 400 along a scanning trajectory T0 created by the robot controller 240. Such an operation of the robot 200 and the liquid ejection head 400 is referred to as a head moving operation.

In step S122, the camera 800 detects the liquid ejection head 400 itself which is performing the head moving operation. Therefore, it is desirable to arrange the camera 800 at a position away from the robot 200. Then, the undulation amount acquisition section 914 of the control device 900 detects a relative track T1 of the liquid ejection head 400 with respect to an object Q.

In step S122, the undulation amount acquisition section 914 of the control device 900 acquires a distance between a scanning trajectory T0 and a track T1 in the orthogonal direction D1 as an initial deviation amount in the orthogonal direction D1. In the present embodiment, a distance between a scanning trajectory T0 and a track T1 in the orthogonal direction D1, which is detected at a constant time cycle, is used as an initial deviation amount in the orthogonal direction D1. The constant time cycle is, for example, a time period in which a distance cycle for acquiring an initial deviation amount is about 1 mm.

Further, the front-rear amount acquisition section 916 of the control device 900 also acquires an initial deviation amount in the printing direction D2. In the present embodiment, a distance between an ideal state and an actual position in the printing direction D2, which is detected at a constant time cycle, is used as an initial deviation amount in the printing direction D2.

Such an operation of the control device 900 is referred to as a deviation amount acquisition operation.

In step S124, the correction amount setting section 918 of the control device 900 calculates a correction amount based on an initial deviation amount obtained by the deviation amount acquisition operation. In step S124, a calculated correction amount is reflected on an operation of the movement stage 300 in real time. As a result, the movement stage 300 can move the liquid ejection head 400 in real time in a direction of reducing the initial deviation amount. As a result, a track T1 is corrected in real time. Such an operation of the control device 900 is referred to as a correction amount calculation operation.

In step S114 of the present embodiment, the camera 800 detects a corrected track T1. Then, the control device 900 acquires a deviation amount between the scanning trajectory T0 and the corrected track T1. In the present embodiment, the deviation amount in the orthogonal direction D1 is defined as an “undulation amount”, and the deviation amount in the printing direction D2 is defined as a “front-rear amount”. The rest is the same as step S114 of the first embodiment. Step S116 and subsequent steps are the same as those in the first embodiment.

Also in the third embodiment as described above, the same effect as in the first embodiment can be obtained.

In the third embodiment, in the overlap width setting step S100, an overlap width can be set without actually performing printing. Therefore, it is not necessary to prepare a temporary object as an object, and it is possible to set an overlap width using an object to be actually printed.

### 4. Effects of Each Embodiment

As described above, the printing method according to the embodiment is a printing method for printing a plurality of lines using a liquid ejection head 400 that ejects ink, the robot 200 that relatively moves the liquid ejection head 400 along a printing direction with respect to an object Q, and a camera 800 (detection section) that detects a relative track of the liquid ejection head 400 with respect to an object Q, and includes an overlap width setting step S100 and a printing step S200. In the overlap width setting step S100, the camera 800 (detection section) acquires an undulation amount of a track in an orthogonal direction D1 (direction orthogonal to a printing direction D2), and an overlap width of the track is set when the plurality of lines is printed based on an acquired undulation amount. In the printing step S200, printing of the plurality of lines is performed on an object Q while the liquid ejection head 400 is relatively moved so that an overlap corresponding to the overlap width is generated in printing of the plurality of lines.

According to such a configuration, since the overlap width of the track when printing the plurality of lines is set based on the undulation amount of the track of the liquid ejection head 400, even in a case where there is vibration or the like in the robot 200, it is possible to suppress the occurrence of a printing failure in which a blank or an overlap becomes conspicuous between lines.

In the overlap width setting step S100, the camera 800 (detection section) may acquire a front-rear amount of the track in the printing direction D2, and the overlap width of the track when printing the plurality of lines may be set based on the acquired undulation amount and the acquired front-rear amount.

According to such a configuration, since the overlap width of the track when printing the plurality of lines is set based on not only the undulation amount but also the front-rear amount, it is possible to further suppress the occurrence of a printing failure.

An object Q when the overlap width setting step S100 is performed and an object Q when the printing step S200 is performed are desirably different from each other. Thus, it is possible to prevent an object to be printed from being stained in the overlap width setting step S100.

The overlap width setting step S100 of the printing method according to a first embodiment is a step including a first pattern printing operation (step S102), a first deviation amount acquisition operation (step S104), a correction amount calculation operation (step S106), a second pattern printing operation (step S108), a second deviation amount acquisition operation (step S110), and an overlap width setting operation (step S116). In the first pattern printing operation, the liquid ejection head 400 prints a first pattern P1 on an object Q while the robot 200 relatively moves the liquid ejection head 400 along the printing direction D2. In the first deviation amount acquisition operation, the camera 800 (detection section) detects the first pattern P1, and a deviation amount of the first pattern P1 in the orthogonal direction D1 (direction orthogonal to the printing direction D2) is acquired based on a detection result. In the correction amount calculation operation, on the basis of a deviation amount acquired from the first pattern P1, the amount of relative movement of the liquid ejection head 400 in a direction of reducing the deviation amount is calculated as a correction amount. In the second pattern printing operation, while the robot 200 relatively moves the liquid ejection head 400 along the printing direction D2 and relatively moves the liquid ejection head 400 in the orthogonal direction D1 based on the correction amount, the liquid ejection head 400 prints a second pattern P2 on an object Q. In the second deviation amount acquisition operation, the camera 800 detects the second pattern P2, and a deviation amount of the second pattern P2 in the orthogonal direction D1 is acquired based on a detection result. In the overlap width setting operation, a deviation amount acquired from the second pattern P2 is set as the undulation amount, and the overlap width is set based on the undulation amount.

According to such a configuration, it is possible to experimentally find an appropriate overlap width for each scanning line, and to print the plurality of lines to which the overlap width is applied. Thus, even when vibration of the robot 200 changes for each scanning line, it is possible to suppress influence on a printing result. In the first embodiment, an overlap width is set based on positions of dots d included in the second pattern P2 after the correction amount is reflected. That is, since the overlap width is set based on a corrected track T2, the overlap width is suppressed from becoming excessively wide, and printing of higher quality can be performed at a higher speed.

An overlap width setting step S100 of a printing method according to a second embodiment is a step including a first pattern printing operation (step S102), a first deviation amount acquisition operation (step S104), and an overlap width setting operation (step S116). In the first pattern printing operation, the liquid ejection head 400 prints a first pattern P1 on an object Q while the robot 200 relatively moves the liquid ejection head 400 along the printing direction D2. In the first deviation amount acquisition operation, the camera 800 (detection section) detects the first pattern P1, and a deviation amount of the first pattern P1 in the orthogonal direction D1 (direction orthogonal to the printing direction D2) is acquired based on a detection result. In the overlap width setting operation, a deviation amount acquired from the first pattern P1 is set as the undulation amount, and the overlap width is set based on the undulation amount.

According to such a configuration, it is possible to experimentally find an appropriate overlap width for each scanning line, and to print the plurality of lines based on the overlap width. Thus, even when vibration of the robot 200 changes for each scanning line, it is possible to suppress influence on a printing result. In the second embodiment, as compared with the first embodiment, since printing and detection of the second pattern P2 can be omitted, it is possible to reduce the number of operations when setting the overlap width, and it is possible to set the overlap width in a shorter time.

The overlap width setting step S100 of the printing method according to a third embodiment is a step including a head moving operation (step S121), a deviation amount acquisition operation (step S122), and an overlap width setting operation (step S116). In the head moving operation, the robot 200 moves the liquid ejection head 400 along the printing direction D2. In the deviation amount acquisition operation, the camera 800 (detection section) detects the track T1 of the liquid ejection head 400, and a deviation amount of the track T1 in the orthogonal direction D1 (direction orthogonal to the printing direction D2) is acquired based on a detection result. In the overlap width setting operation, a deviation amount acquired from the track T1 is set as the undulation amount, and the overlap width is set based on the undulation amount.

According to such a configuration, it is possible to experimentally find an appropriate overlap width for each scanning line, and to print the plurality of lines to which the overlap width is applied. Thus, even when vibration of the robot 200 changes for each scanning line, it is possible to suppress influence on a printing result. In the third embodiment, the overlap width can be set from an image of the liquid ejection head 400 without actually performing printing. Therefore, it is not necessary to prepare a temporary object as an object Q, and it is possible to set the overlap width using an object to be actually printed.

It is desirable that, in the printing step S200, the liquid ejection head 400 performs printing of the plurality of lines by thinning out dots in a range OL corresponding to the overlap width. Thus, an excessive increase in the print density in the range OL is suppressed.

The robot system (printing device 100) according to the embodiment is a device for printing a plurality of lines on an object Q, and includes a liquid ejection head 400, a robot 200, a camera 800 (detection section), and a print control section 910. The liquid ejection head 400 ejects ink (liquid) to an object Q. The robot 200 includes a robot arm 220 that relatively moves the liquid ejection head 400 along a printing direction D2 with respect to the object Q. The camera 800 detects the relative track of the liquid ejection head 400 with respect to an object Q. The print control section 910 controls operations of the liquid ejection head 400 and the robot 200. The print control section 910 includes an undulation amount acquisition section 914 and an overlap width setting section 920. The undulation amount acquisition section 914 acquires an undulation amount of a track in an orthogonal direction D1 (a direction orthogonal to the printing direction D2). The overlap width setting section 920 sets an overlap width between the tracks when printing the plurality of lines based on the acquired undulation amount.

Then, in the printing device 100, the liquid ejection head 400 prints the plurality of lines on an object Q while the robot 200 relatively moves the liquid ejection head 400 so that an overlap occurs corresponding to the overlapping width in printing the plurality of lines.

According to such a configuration, since the overlap width of the track when printing the plurality of lines is set based on the undulation amount of the track of the liquid ejection head 400, even in a case where there is vibration or the like in the robot 200, it is possible to suppress the occurrence of a printing failure in which a blank or an overlap becomes conspicuous between lines.

Desirably, the robot 200 includes a movement stage 300. The movement stage 300 is provided between the robot arm 220 and the liquid ejection head 400, and moves the liquid ejection head 400 in the orthogonal direction D1 (the direction orthogonal to the printing direction D2) with respect to the robot arm 220.

According to such a configuration, the movement stage 300 can correct a position of the liquid ejection head 400 with higher accuracy and at higher speed than the robot arm 220. As a result, higher quality printing can be performed at a higher speed.

It is desirable that the print control section 910 includes a front-rear amount acquisition section 916 that acquires a front-rear amount of a track in the printing direction D2.

According to such a configuration, the print control section 910 can set the overlap width based on not only the undulation amount but also a front-rear amount. Therefore, it is possible to suppress the occurrence of a printing failure to a smaller extent.

It is desirable that the print control section 910 controls an operation of the liquid ejection head 400 so as to thin out dots in a range OL corresponding to the overlap width.

According to such a configuration, an excessive increase in the print density in the range OL is suppressed.

Although the printing method and the robot system of the present disclosure have been described based on the embodiments shown in the drawings, the printing method and the robot system of the present disclosure are not limited to the above-described embodiments. For example, the printing method according to the present disclosure may be a method in which a step or an operation for an arbitrary purpose is added to the above-described embodiments. In the robot system according to the present disclosure, each section of the embodiment may be replaced with an arbitrary configuration having the same function, and an arbitrary component may be added to the embodiment.

What is claimed is:

1. A printing method for printing a plurality of lines using
an ink ejection head that ejects ink;
a robot that relatively moves the ink ejection head along a printing direction with respect to an object; and
a detection section that detects a relative track of the ink ejection head with respect to an object,
the printing method comprising:
an overlap width setting step of the detection section acquiring an undulation amount of the track in a direction orthogonal to the printing direction, and of setting an overlap width of the track when printing the plurality of lines based on the acquired undulation amount and
a printing step of printing the plurality of lines on an object while the ink ejection head relatively moves so as to generate an overlap corresponding to the overlap width in printing the plurality of lines.

2. The printing method according to claim 1, wherein
the overlap width setting step is a step of the detection section acquiring a front-rear amount of the track in the printing direction, and of setting the overlap width of the track when printing the plurality of lines based on the acquired undulation amount and the acquired front-rear amount.

3. The printing method according to claim 1, wherein
the object when the overlap width setting step is performed and the object when the printing step are different objects from each other.

4. The printing method according to claim 1, wherein
the overlap width setting step is a step including
a first pattern printing operation in which the ink ejection head prints a first pattern on an object while the robot relatively moves the ink ejection head along the printing direction,
a first deviation amount acquisition operation of the detection section detecting the first pattern, and of acquiring a deviation amount of the first pattern in a direction orthogonal to the printing direction based on a detection result,
a correction amount calculation operation of calculating, as a correction amount, an amount by which the ink ejection head is relatively moved in a direction for reducing the deviation amount, based on the deviation amount acquired from the first pattern,
a second pattern printing operation in which the ink ejection head prints a second pattern on an object while the robot relatively moves the ink ejection head along the printing direction and relatively moves the ink ejection head in a direction orthogonal to the printing direction based on the correction amount,
a second deviation amount acquisition operation of the detection section detecting the second pattern, and of acquiring a deviation amount of the second pattern in a direction orthogonal to the printing direction based on a detection result, and
an overlap width setting operation in which the deviation amount acquired from the second pattern is set as the undulation amount, and the overlap width is set based on the undulation amount.

5. The printing method according to claim 1, wherein
the overlap width setting step is a step including
a first pattern printing operation in which the ink ejection head prints a first pattern on an object while the robot relatively moves the ink ejection head along the printing direction,
a first deviation amount acquisition operation of the detection section detecting the first pattern, and of acquiring a deviation amount of the first pattern in a direction orthogonal to the printing direction based on a detection result, and
an overlap width setting operation in which the deviation amount acquired from the first pattern is set as the undulation amount, and the overlap width is set based on the undulation amount.

6. The printing method according to claim 1, wherein
the overlap width setting step is a step including
a head moving operation in which the robot relatively moves the ink ejection head along the printing direction,
a deviation amount acquisition operation of the detection section detecting a track of the ink ejection head, and of acquiring a deviation amount of the track in a direction orthogonal to the printing direction based on a detection result, and
an overlap width setting operation of setting the deviation amount acquired from the track as the undulation amount, and setting the overlap width based on the undulation amount.

7. The printing method according to claim 1, wherein
the printing step is a step in which the ink ejection head prints the plurality of lines by thinning out dots in a range corresponding to the overlap width.

8. A robot system for printing a plurality of lines on an object, the robot system comprising:
an ink ejection head that ejects ink;
a robot including a robot arm that relatively moves the ink ejection head along a printing direction with respect to an object;
a detection section that detects a relative track of the ink ejection head with respect to an object; and
a print control section that controls operations of the ink ejection head and the robot, wherein
the print control section includes
an undulation amount acquisition section that acquires an undulation amount of the track in a direction orthogonal to the printing direction and
an overlap width setting section that sets an overlap width between the tracks when the plurality of lines is printed based on the acquired undulation amount and
the ink ejection head prints the plurality of lines on an object while the robot relatively moves the ink ejection head so that an overlap corresponding to the overlap width is generated in printing the plurality of lines.
